(19) United States
(12) Patent Application Publication
(10) Pub. No.: US 2013/0173312 A1
(43) Pub. Date: Jul. 4, 2013

(54) SYSTEM AND METHOD FOR FLEXIBLE TERM RIDERS FOR RISK MANAGEMENT PRODUCTS

(71) Applicant: METROPOLITAN LIFE INSURANCE CO., New York, NY (US)

(72) Inventor: Paul Wetmore, Bridgewater, NJ (US)

(73) Assignee: METROPOLITAN LIFE INSURANCE CO., New York, NY (US)

(21) Appl. No.: 13/724,077

(22) Filed: Dec. 21, 2012

Related U.S. Application Data
(60) Provisional application No. 61/581,195, filed on Dec. 29, 2011.

(51) Int. Cl. G06Q 40/08

(52) U.S. Cl. CPC G06Q 40/08
USPC 705/4

(57) ABSTRACT

The present disclosure comprises a method implemented on a program-controlled computer processor and a system for generating and processing life insurance policies with a whole life component and a term life component. In one embodiment, the system will provide a rider (or “flex term rider”) for whole life policies that allows the initial policy to be blended with term life insurance. The percentage of the term life coverage may vary; for example, 50% of the coverage can be term life insurance. The lower the percentage of term life in the product blend, the higher the premiums will be.

### BACKGROUND

Two of the most popular life insurance policy types are term life and whole life. Term life insurance pays a predetermined sum to a beneficiary if the insured's death occurs during a set number of years (the term of the insurance contract). Whole life insurance pays a guaranteed death benefit to a beneficiary when the insured dies, regardless of when death occurs.

There are many different variations of term life insurance policies and even more of whole life insurance policies. For example, there is “ordinary life” which provides whole life insurance with premiums that are payable during an entire lifetime. Other names for ordinary life include “straight life” and “continuous-premium whole life”. There is also “limited-payment whole life” policies where the face amount of the policy is payable at death, but premiums are charged for a limited number of years, after which the policy becomes paid-up for its full face amount.

There is also “indeterminate-premium whole life insurance”. The key to this contract is a premium that is lower than the maximum permissible contractual obligation. In effect, a significant discount from the maximum premium is guaranteed for the first few contract years. Annually thereafter, the premium actually payable is set by the company, subject to a maximum constraint. The policy is designed to reflect, through its premium structure, up-to-date expectations as to future operating experience.

Another kind of insurance is “current assumption whole life” where policies provide life insurance under a non-traditional, transparent format that relies on an indeterminate-premium structure. These policies typically use new-money interest rates and current mortality tables in their cash-value determination. This fact has led to the products being referred to as “interest-sensitive whole life”. Yet another kind of policy is “variable life insurance” which is whole life insurance whose values will vary directly with the performance of a set of earmarked investments.

Term contracts or policies typically have no cash values whereas the opposite is true of whole life policies. The tradeoff between the cash value of whole life insurance over term life insurance is reflected by the lower premiums for term life insurance. There is a need for a system to determine a user's preference between cash value growth in the future and lower premiums. There is also a need for a risk management product customized to suit a customer's preference with respect to future cash value growth and lower premiums.

### BRIEF DESCRIPTION OF THE DRAWINGS

FIG. 1 represents an exemplary system, in accordance with certain embodiments of the present invention.

FIG. 2 represents a flow diagram, in accordance with certain embodiments of the present invention.

FIG. 3 illustrates a questionnaire presented to a user, in accordance with certain embodiments of the present invention.

FIG. 4 is table of guaranteed cash values, in accordance with certain embodiment of the present invention.

FIG. 5 is an example rider specification, in accordance with certain embodiments of the present invention.

FIG. 6 is a table of guaranteed maximum term costs, in accordance with certain embodiments of the present invention.

### DETAILED DESCRIPTION OF THE INVENTION

The present invention comprises a method implemented on a program controlled data processor and a system for generating and processing life insurance policies with a whole life component and a term life component. The following description is meant to be illustrative and not limiting.

In a preferred embodiment, the system will provide a rider (or “flex term rider”) for whole life policies that allows the initial policy to be blended with term life insurance. The percentage of the term life coverage may vary; for example, 50% of the coverage can be term life insurance. The lower the percentage of term life in the product blend, the higher the premiums will be. Optionally, the term portion of the policy will be fully convertible to other available permanent products until a threshold age; in one example, 65.

In one example, the term portion of the policy will be funded annually with non-guaranteed dividends and out-of-pocket premiums. The premiums or dividends not needed to pay for the term cost will be used to buy paid-up additions. As the death benefit from paid-up additions increases, less term insurance is required to keep the total death benefit level. Over time, the paid-up additions may become large enough that term insurance is no longer necessary to keep a level face amount. At this time, no more term insurance is purchased and all future dividends will go to paid-up additions.

In one embodiment, the values within the flex term rider depend on premiums, dividends, and term costs, which are not guaranteed. In another embodiment, the flex term rider may come with a guarantee that even if dividends are never paid on the policy or if the term costs increase above what was originally projected, payment of the quoted premium will guarantee total coverage until a threshold age; for example 85. If there is still a need for term insurance after the threshold age, additional premium may be required or there may be a reduction in coverage.

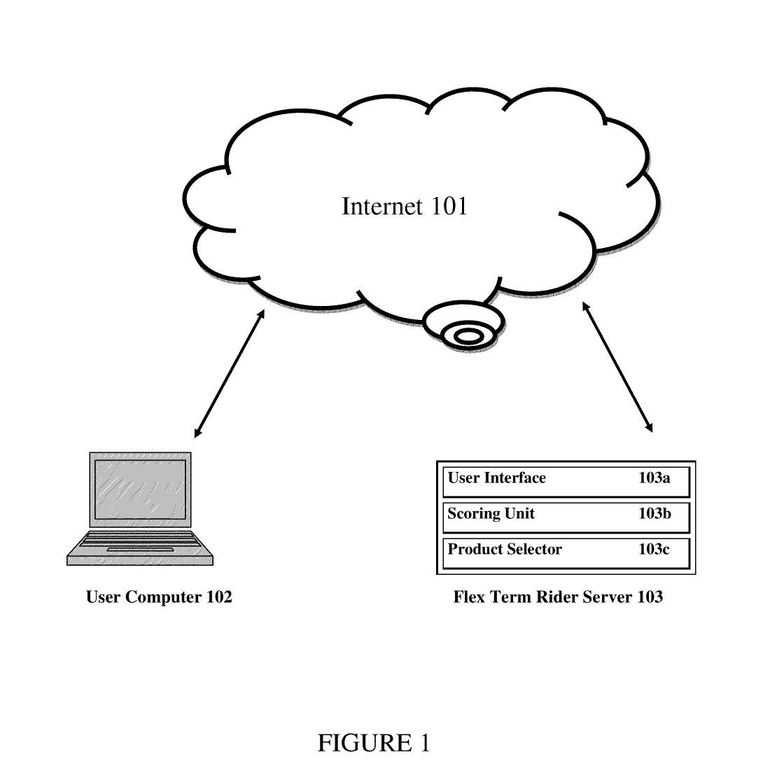

FIG. 1 illustrates system 100, an embodiment of the present invention. Flex Term Rider Server 103 is operable to communicate with User Computer 102 via Internet 101. Flex Term Rider Server 103a contains three components: User Interface 103a, Scoring Unit 103b, and Product Selector 103c. User Interface 103a controls the visual presentations sent to User Computer 102 including questionnaires (discussed below). Scoring Unit 103b calculates questionnaire scores (discussed below) based on input from User Computer 102. Product Selector 103 determines which Flex Term Rider options and/or products are to be presented to User Computer 102 based on the score calculated by Scoring Unit 103b.

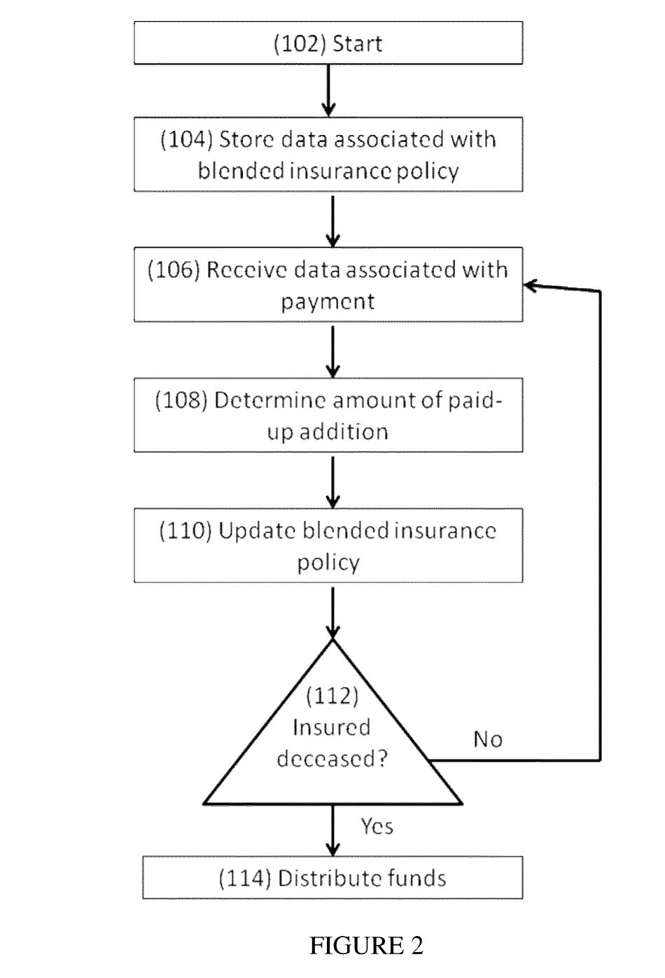

FIG. 2 represents a flow diagram in accordance with certain embodiments of the present invention. The process flow begins at step 102 and proceeds to step 104, where data associated with a blended insurance policy is stored, for example, in a non-transitory computer-readable storage medium. The blended insurance policy is comprised of a whole life insurance portion and a term life insurance portion. In one embodiment, the blended insurance policy is created when a flex term rider, discussed in further detail below, is associated with a whole life insurance policy. At step 106, data associated with a payment is received, for example, through a network connection. The payment can include a premium paid by the insured, as well as policy (and other) dividends. The amount of paid-up addition is determined, at step 108. Based on the amount of the paid-up addition, the blended insurance policy is updated at step 110. For example, the greater the amount of paid-up addition, the greater the decrease in the term life portion of the blended insurance policy. At step 112, it is determined whether the insured is deceased. If the insured is not deceased, the process flow loops to step 106. If the insured is deceased, the death benefit is provided to the beneficiary, at step 114.

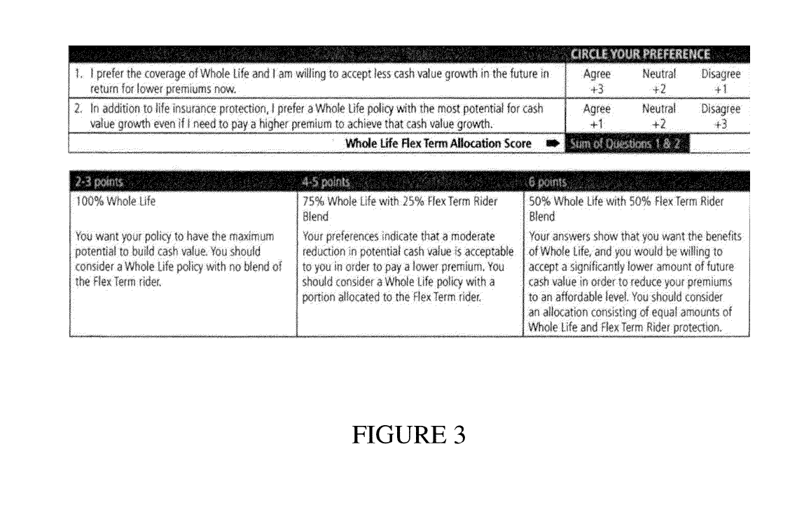

In one aspect of the present invention, a questionnaire is provided to a user. The questionnaire may be provided over the internet to a personal computer, mobile device, or other well known means. The questionnaire will include questions that indicate a user's preference towards future cash value growth over lower premiums. For example, questionnaires may include the following statements: 1) I prefer the coverage of Whole Life and I am willing to accept less cash value growth in the future in return for lower premiums now; 2) In addition to life insurance protection, I prefer a Whole Life policy with the most potential for cash value growth even if I need to pay a higher premium to achieve that cash value growth. The system provides the users with options to indicate whether they agree, are neutral to, or disagree with those statements. Different degrees of agreement or disagreement may also be provided. The system is configured to receive the users' selections. In one embodiment, a numerical score will be assigned to each potential answer choice. Based on a user's answer choices, a score is calculated and represents the user's preference between future cash value and lower premiums. The system can then use this score to present the user with a flex term rider optimized for the user's preferences. FIG. 3 illustrates a questionnaire presented to a user, along with various options that may be presented to the user based on their scores. For example, based on the score, the system may recommend 100% whole life (no flex term rider), 75% whole life with 25% flex term rider, or 50% whole life with 50% flex term rider.

Example flex term rider terms are detailed below. References to “we” refer to the insurance provider, and references to “you” refer to the policy owner.

The Additional Insurance Amount for each subsequent rider year will consist of Paid-Up Additions and One-Year Term Insurance (known as One-Year Term), the mix of which is subject to change each year. It will be provided by the Purchase Amount, which equals the premium payments under this Rider plus dividends credited to the Policy plus any Cash Value of existing Paid-Up Additions. The Purchase Amount will be used to buy a combination of One-Year Term and Paid-Up Additions to equal the Additional Insurance Amount.

If the Purchase Amount is not sufficient to buy One-Year Term equal to the Additional Insurance Amount, we will send you a notice stating the amount needed. You may send us that amount or you may use the Cash Value of any other existing dividend balances. This additional premium will not be waived under any waiver of premiums benefit rider. If we do not receive this payment within 31 days from the rider anniversary, the Additional Insurance Amount of this Rider will be reduced to the amount of One-Year Term, unless the Guaranteed Amount is in effect.

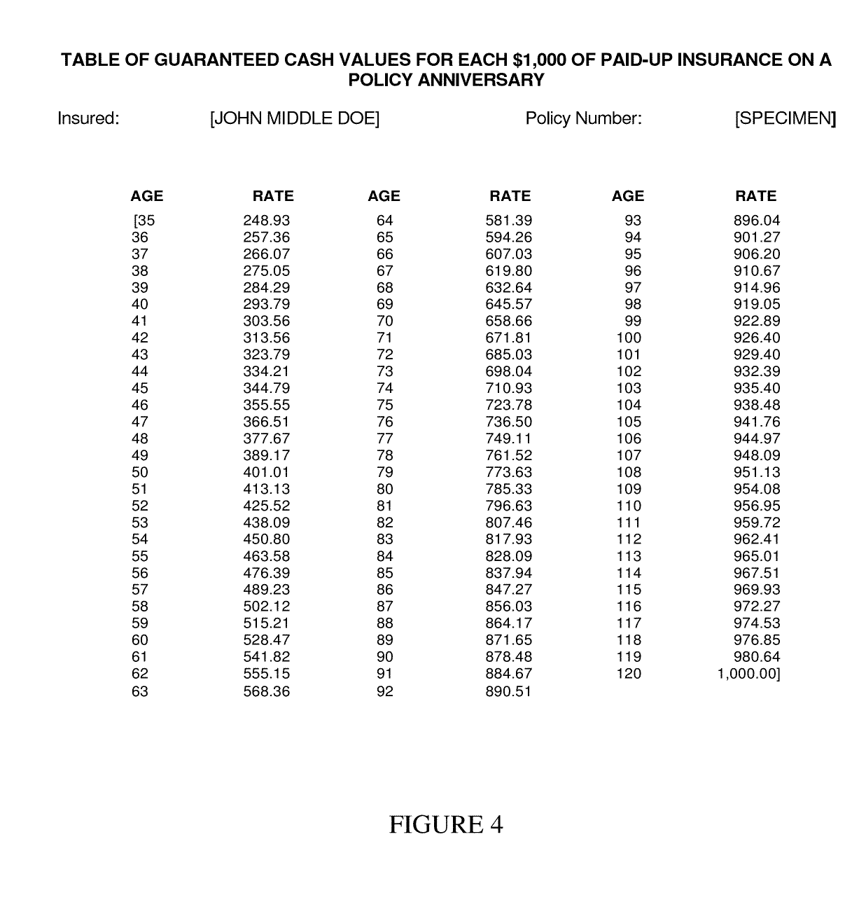

The amount of Paid-Up Additions bought by the Purchase Amount, minus the Premium Load and one-year term insurance costs, is computed by dividing that amount by an applicable factor. These factors are the net single premium factors, which are based on the Insured's Attained Age, the Mortality Table shown on the Table of Guaranteed Values of the Policy and a set percentage per year. The factors can be determined by dividing the values shown in the Table of Guaranteed Cash Values for Each $1,000 of Paid-Up Insurance on a Policy Anniversary by 1,000; an example of which is provided in FIG. 4. You can determine a factor on a date during the year by interpolation between factors for the anniversary just before and just after that date.

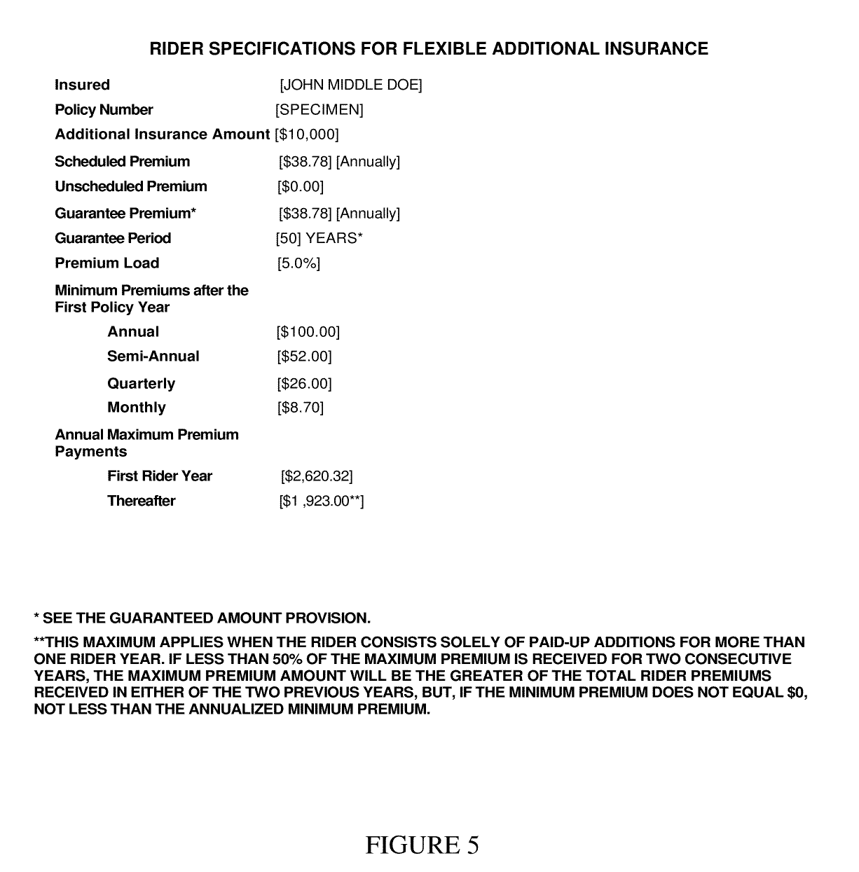

The Minimum Premium shown on the Rider Specifications is the minimum amount that you may pay each rider year beginning one rider year after this Rider consists solely of Paid-Up Additions. An example of a Rider Specification is provided in FIG. 5.

The Scheduled Premium shown on the Rider Specifications is the amount you selected to pay when this Rider was issued, but it may be changed on any subsequent policy anniversary if this Rider does not consist solely of Paid-Up Additions. Otherwise, the amount you selected to pay when this Rider was issued may be changed at any time beginning one rider year after this Rider consists solely of Paid-Up Additions.

The Scheduled Premium will be paid under the Automatic Premium Loan provision of the Policy if:
1. The premium described in that provision plus the Scheduled Premium of this Rider are not paid by the end of the Policy's grace period;
2. The automatic premium loan option of the Policy has been chosen;
3. This Rider is in effect and does not consist solely of Paid-Up Additions, or has consisted solely of Paid-Up Additions for less than one rider year; and
4. There is sufficient Loan Value to pay the full amount described in item 1 above.

If the available Loan Value is not sufficient to pay the full amount described in item 1 above, no premiums will be paid and the Policy will lapse.

If the Scheduled Premium is not paid with the Policy premium on the current schedule, the Policy and Rider will lapse if: this Rider does not consist solely of Paid-Up Additions; or this Rider consists solely of Paid-Up Additions for less than one rider year.

You may also make an Unscheduled Premium payment on each policy anniversary if: this Rider does not consist solely of Paid-Up Additions; or this Rider consists solely of Paid-Up Additions for less than one rider year. We must receive your Unscheduled Premium payment within 31 days of a policy anniversary. When we receive your Unscheduled Premium payment, the mix of Paid-Up Additions and One-Year Term will be recalculated.

If this Rider consists solely of Paid-Up Additions, you may also make an Unscheduled Premium payment at any time beginning one rider year after this Rider consists solely of Paid-Up Additions, subject to the minimums and maximums.

The total amount of all premiums that may be paid during the first rider year and any year in which the coverage under this Rider consists solely of Paid-Up Additions for more than one rider year is shown in the Maximum Premium Amount on the Rider Specifications.

If you receive a bill that includes the Scheduled Premium amount and you send in an amount that is greater than the total shown on the bill, we will apply all payments received for your Policy and Benefit Riders in the following order:
1. To pay any premium due for the Policy and other Benefit Riders, if any, attached to the Policy;
2. To pay the Scheduled Premium for this Rider;
3. To pay the interest due on a Policy Loan;
4. To be paid as an Unscheduled Premium for this Rider, subject to the minimum and maximum limits and your right to pay; and then
5. To pay a Policy Loan. If the Policy is changed to a fully Paid-Up policy, premiums cannot be paid under this Rider.

If this Rider consists solely of Paid-Up Additions for more than one rider year and you make no premium payments under this Rider for a two full consecutive years, your right to make premium payments under this Rider will end. That right can be reinstated when you submit proof satisfactory to us that the Insured is insurable by our standards.

For the purposes of counting the two year period indicated above:
1. If premiums are being waived under an Insured's waiver of premium rider, the two year period will begin anew when the waiving of premiums ends.
2. If your right to make premium payments for this Rider ends solely because the Policy lapsed, that right will be reinstated once the Policy has been reinstated. When the Policy is reinstated, the counting of the two year period will begin anew.

All premiums received are subject to the Premium Load shown in the Rider Specifications.

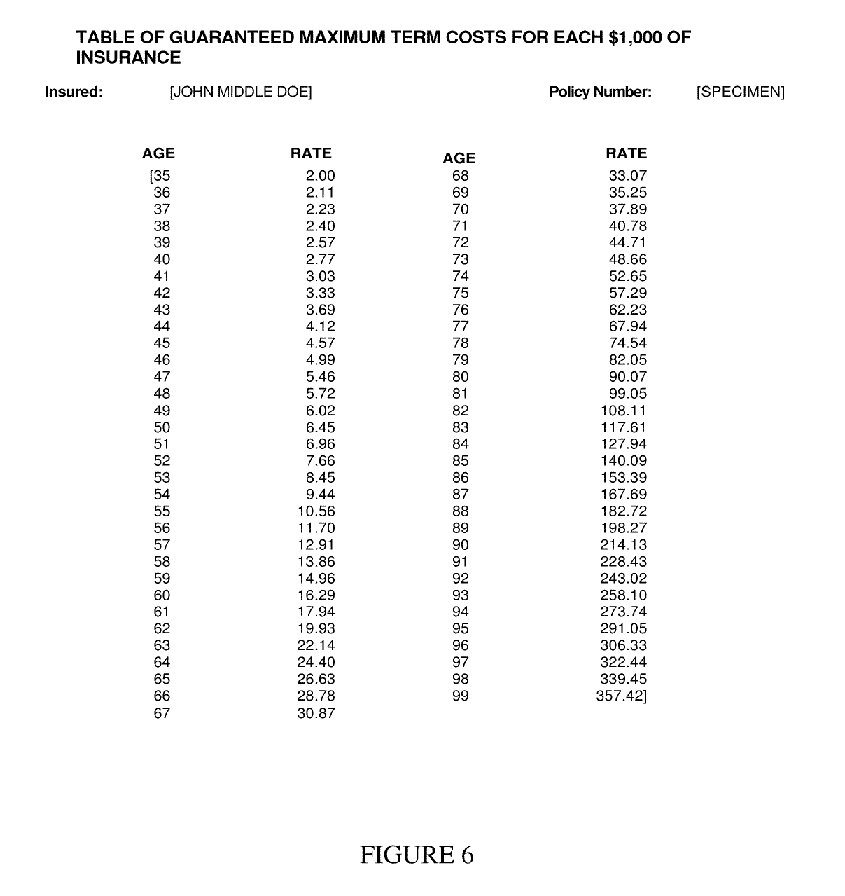

Each year we will set the cost of the One-Year Term under this Rider. Your cost for each $1,000 of term insurance will never be greater than the costs shown in the Table of Guaranteed Maximum Term Costs for Each $1,000 of Insurance; an example of which is provided in FIG. 6.

If you pay the Guarantee Premium shown on the Rider Specifications for the Guarantee Period, we will guarantee the Additional Insurance Amount during the Guarantee Period. To maintain this guarantee your cumulative premium payments, less any withdrawals from the cash value of this Rider, during the Guarantee Period must at least equal the total amount of Guarantee Premium due during that period. If not, your guarantee will end. Once terminated, the guarantee cannot be reinstated. When the guarantee is no longer in effect, the Additional Insurance Amount will equal: the amount of Paid-Up Additions; plus the amount of One-Year Term.

If premium payments for the Policy are being waived under an Insured's waiver of premiums benefit, we will waive:
1. Your Scheduled Premium payment that was in effect when the Insured's total disability began, if this Rider does not consist solely of Paid-Up Additions or this Rider consists solely of Paid-Up Additions for less than one rider year; otherwise
2. Your Scheduled Premium payment that was in effect on the date this Rider first consisted solely of Paid-Up Additions for one rider year.

The Scheduled Premium waived may be different than the Scheduled Premium at issue of this Rider. (See the Scheduled Premium provision concerning allowed changes to the Scheduled Premium.)

While the Scheduled Premium payment is being waived, an Unscheduled Payment can only be made:
1. On a policy anniversary if it is required to keep the Guaranteed Amount in effect; and
2. On a policy anniversary if it is required to prevent the Additional Insurance Amount from being reduced.

While the Insured is alive, the paid-up portion of this benefit has a cash value that may be determined using the Table of Guaranteed Cash Values for Each $1,000 of Paid-Up Insurance on a Policy Anniversary. You can determine a cash value on a date during the year by interpolation between the factors for the anniversary just before and just after that date.

The cash value of this Rider is available as part of the collateral for a loan under the Policy. The terms of the Loans provision of the Policy apply.

We will add the Additional Insurance Amount under this Rider to the Policy's Face Amount to compute the amount of extended term insurance under the Nonpayment of Premiums provision of the Policy. We will also include the cash value of the paid-up insurance in computing the length of extended term insurance or the amount of reduced paid-up insurance.

You may withdraw all or some of the cash value of this Rider by surrendering Paid-Up Additions. If you withdraw any cash value, the Additional Insurance Amount will be reduced.

If you surrender Paid-Up Additions, we will reduce the amount of Paid-Up Additions. When Paid-Up Additions are automatically surrendered on an annual premium due date to pay all of the annual premium as a result of your written request, the mix of Paid-Up Additions and One-Year Term will be recalculated.

Each year we determine an amount to be paid to our policyholders as dividends. We will determine the share, if any, for this Rider and credit it as a dividend to the Policy. This Rider limits the ways you may use dividends. When this Rider is in effect and consists solely of Paid-Up Additions for more than one rider year, you may choose any dividend option. Otherwise, all dividends payable will be used to fund this Rider.

You may convert One-Year Term, without evidence of insurability, to a new policy on the life of the Insured. The conversion must be effective as of a policy anniversary: during the first 10 policy years; or prior to the policy anniversary on which the Insured is age 65, if later. The conversion is subject to the following:
1. The amount of life insurance provided by the new policy may not be more than the One-Year Term in effect under this Rider on the last day of the prior policy year;
2. The new policy must be a permanent life plan issued by us or one of our affiliates and must be on a plan agreed to by the issuing company, to the extent available for sale by that company on the policy date of the new policy and subject to any limits under Federal income tax and other applicable rules;
3. The underwriting class of the new policy will be the same as the class for this Rider, or the class the issuing company determines is the closest to it if that class is not offered on the new policy;
4. Premiums for the new policy will be those in effect on the date of conversion at the Insured's sex and based on the Insured's date of birth;
5. The new policy will not become effective until the first full premium is paid. If you convert this Rider, we may apply a conversion credit;
6. If you convert this Rider within two years after its Issue Date, we will rely on the representations in the application for this Rider; and
7. In the new policy, the Suicide and Incontestability provisions for the coverage resulting from the conversion will be measured from the Issue Date of this Rider rather than from the issue date of the new policy.

The conversion can be made only with the consent of the Company if:
1. The face amount of the new policy would be less than the Company's published minimum limits of issue; or
2. Any rider is to be attached to the new policy.

If this Rider ends solely due to the lapse of the Policy, it may be reinstated when the Policy is reinstated. If the Additional Insurance Amount was guaranteed at the time of lapse, the guarantee may also be reinstated if all Guarantee Premiums due are also paid. If this Rider consists solely of Paid-Up Additions for more than one rider year and the right to pay premiums is in effect when the Policy lapses, the right to pay premiums will also be reinstated.

If we determine while the Insured is still alive that there was a misstatement of age or sex reflected in the Rider, we will recalculate the amount of Paid-Up Additions and One-Year Term insurance from the Issue Date of this Rider based on the correct information.

If we determine at the time of the Insured's death that there was a misstatement of age or sex reflected in the Rider, we will recalculate the amount of Paid-Up Additions and One-Year Term insurance as of the date of death by using the net single premium factors and term costs for the correct age and sex.

This Rider will not be contestable after it has been in force during the life of the Insured for two years from the Issue Date of this Rider.

If the Insured dies by suicide, while sane or insane, within two years from the Issue Date of this Rider:
1. The Rider will terminate; and
2. The amount payable under this Rider will be limited to the premiums paid (without interest) for this Rider, less any withdrawals.

The One-Year Term in force under this Rider will end on the earliest of:
1. The date of our receipt of your request In Writing to end this Rider;
2. The date the One-Year Term is converted;
3. The policy anniversary on or following the date we receive your request for a change of dividend option;
4. The date the Policy becomes fully paid-up;
5. The policy anniversary on which the Insured is age 100; and
6. The date the Additional Insurance Amount consists solely of Paid-Up Additions. After the One-Year Term in force under this Rider ends, no One-Year Term can be purchased.

This Rider will terminate on the earliest of:
1. The date the Policy lapses;
2. The date the Policy terminates; and
3. The date of our receipt of your request In Writing to terminate this Rider.

It is understood that the above flex term rider terms are exemplary and not limiting, and may be customized according to the individual customer and/or industry standards.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a tablet, a smartphone, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

What is claimed:

1. A computer-implemented method, comprising:
storing in a non-transitory computer-readable medium data associated with a blended insurance policy, wherein said blended insurance policy comprises a whole life portion and a term life portion;
receiving through a network connection data associated with a payment, said payment comprising a premium;
determining, by a program-controlled computer processor, an amount of paid-up addition based on said payment; and
updating, by the computer processor, the blended insurance policy based on the determined amount of paid-up addition.

2. The computer-implemented method of claim 1 wherein said updating the blended insurance policy comprises replacing the term life portion with a portion associated with the amount of paid-up addition.

3. The computer-implemented method of claim 1 further comprising the step of creating a blended insurance policy by associating a flex term rider with a whole life insurance policy.

4. The computer-implemented method of claim 1 wherein the blended insurance policy has an associated death benefit value, and further wherein said death benefit value remains level after said update to the blended insurance policy.

5. The computer-implemented method of claim 1 wherein said payment includes policy based dividends.

6. The computer-implemented method of claim 1 wherein said blended insurance policy provides a guaranteed death benefit to a predefined age if a predetermined premium is paid.

7. The computer-implemented method of claim 6 wherein said predefined age is 85 years old.

8. A computer-implemented method for processing risk management product data associated with a risk management policy, comprising:
storing in a non-transitory computer readable medium data associated with a whole life insurance policy;
receiving, by a program-controlled computer processor, a request to associate a flex term rider with said whole life insurance policy; and
updating, by said computer processor, said data associated with said whole life insurance policy to include data associated with said flex term rider;
wherein said flex term rider reduces current premiums and future cash value associated with said whole life insurance policy.

9. The computer-implemented method of claim 8 wherein said whole life insurance policy associated with said flex term rider provides a guaranteed death benefit to a predefined age if a predetermined premium is paid.

10. The computer-implemented method of claim 9 wherein said predefined age is 85 years old.

11. The computer-implemented method of claim 8 further comprising associating a paid-up addition to the whole life insurance policy.

12. The computer-implemented method of claim 1 wherein the whole life insurance policy associated with the flex term rider has an associated death benefit value, and further wherein said death benefit value remains level at least until a predefined age is reached.

13. A system comprising:
a computer processor selectively programmed to determine a user's preference between future cash value growth and current premiums;
said computer processor further programmed such that if said user's preference for future cash value growth exceeds a threshold, then said computer processor presents said user with an option to select a flex term rider;
a network connection to receive said user's input; and
an electronic database for storing risk management product data, including said user's selection of said flex term rider;
wherein said flex term rider reduces current premiums and future cash value associated with a whole life insurance policy.

14. A system comprising:
a non-transitory computer-readable medium configured to store data associated with a blended insurance policy, wherein said blended insurance policy comprises a whole life portion and a term life portion;
a network connection configured to receive data associated with a payment, said payment comprising a premium; and
a program-controlled computer processor configured to:
determine an amount of paid-up addition based on said payment; and
update the blended insurance policy based on the determined amount of paid-up addition.

15. The system of claim 14 wherein said updating the blended insurance policy comprises replacing the term life portion with a portion associated with the amount of paid-up addition.

16. The system of claim 14 wherein said computer processor is further configured to create a blended insurance policy by associating a flex term rider with a whole life insurance policy.

17. The system of claim 14 wherein the blended insurance policy has an associated death benefit value, and further wherein said death benefit value remains level after said update to the blended insurance policy.

18. The system of claim 14 wherein said payments include policy based dividends.

19. The system of claim 14 wherein said blended insurance policy provides a guaranteed death benefit to a predefined age if a predetermined premium is paid.

20. The system of claim 19 wherein said predefined age is 85 years old.
